(19) United States
(12) Patent Application Publication
(10) Pub. No.: US 2023/0227085 A1
(43) Pub. Date: Jul. 20, 2023

(54) WHEEL BRAKE FOR A WAGON

(71) Applicants: Brian Horowitz, Lake Forest, CA (US); William F. Ryczek, Pomona, CA (US); Thomas Wai-Yan Wang, Alhambra, CA (US)

(72) Inventors: Brian Horowitz, Lake Forest, CA (US); William F. Ryczek, Pomona, CA (US); Thomas Wai-Yan Wang, Alhambra, CA (US)

(21) Appl. No.: 17/576,495

(22) Filed: Jan. 14, 2022

(51) Int. Cl. B62B 3/00; B62B 5/04; B62B 9/08; B60B 33/02

(52) U.S. Cl. CPC B62B 3/007; B62B 5/0433; B62B 9/082; B60B 33/023

(57) ABSTRACT

A wheel brake is disclosed to communicate with at least one wheel of a wheeled article (e.g., a wagon) to prevent the wheel from rotating and the wheeled article from rolling away. A toothed locking gear is attached to a hub of the wheel so that the wheel and the locking gear rotate together. A brake pedal of the wheel brake is pivotally connected to the wagon at a wheel bracket thereof to be rotatable in response to a pushing force applied thereto towards and into locking engagement with the locking gear. A coupler (e.g., a locking pin) of the brake pedal is received between a successive pair of teeth of the toothed locking gear, such that the locking gear and the wheel to which the locking gear is attached are unable to rotate, whereby the wheeled article is held in place.

### BACKGROUND OF THE INVENTION

### 1. Field of the Invention

This invention relates to a wheeled article, such as a wagon, that has one or more wheel brakes and a corresponding number of locking gears that are connected to respective wheels at hubs thereof. The wheel brakes are pivotally connected to wheel brackets at the corners of the wagon so as to be rotatable into locking engagement with the locking gears in order to prevent a rotation of the wheels and a displacement of the wagon from one place to another.

### 2. Background Art

Rolling wagons for carrying goods and even small children are well known to both the young and old. Such rolling wagons typically include four rotating wheels located at the four corners of the wagon. When a wagon is parked, and especially when the wagon is intended to remain stationary on an inclined surface, it ma be necessary to hold the wagon in place by preventing one or more of its wheels from rotating so that the wagon will not move from its intended location. A block of wood or stone is often placed in contact with a wheel to hold the wagon still. However, such blocks cannot always be trusted to remain in contact with the wheel to be controlled. What would therefore be desirable is a reliable and simple to use braking system to be carried by a wagon or another wheeled vehicle and moved into locking engagement with one or more wheels of the wagon to prevent the wheel or wheels from rotating so that the wagon cannot inadvertently roll away.

### SUMMARY OF THE INVENTION

A wheel brake is disclosed that is carried by a wheeled article and adapted to be moved into engagement with at least one wheel of the wheeled article for preventing the wheel from rotating and thereby holding the wheeled article in place. In accordance with a preferred embodiment, the wheeled article that carries the wheel brake is a wagon. In this case, the wheel is connected to a corner of the wagon by a wheel bracket having a pair of wings between which the wheel is located. The wheel incudes a hub at the center thereof and a set of spokes that extend radially from the hub to a tire that surrounds the hub. A corresponding set of spoke covers are detachably connected to respective ones of the spokes to minimize vibrations to which the wheel may be subjected when the wagon rolls from place to place.

A locking gear is connected to the wheel at its hub. A bolt extends through the hub of the wheel, the pair of wings of the wheel bracket and the wheel located between the pair of wings, and the locking gear that is connected to the hub to establish an axle around which the wheel and the locking gear rotate with one another when the wagon is moved. The locking gear has a plurality of teeth that are spaced from one another. The wheel brake includes a brake pedal that is pivotally connected to the wagon at one of the wings of the wheel bracket. The brake pedal is responsive to a pushing force applied thereto so as to rotate towards and into locking engagement with the locking gear. More particularly, a coupler that depends from a push pad of the brake pedal is received between a successive pair of the teeth of the locking gear to prevent a rotation of the wheel and thereby hold the wagon in its place.

### BRIEF DESCRIPTION OF THE. DRAWINGS

FIG. 1 shows wheels located at the corners of a wagon and a wheel brake communicating with at least one of the wheels by which to prevent the rotation of the wheel and the ability of the wagon to roll from place to place;

FIG. 2 is an enlarged view of the wheel brake shown in FIG. 1 and the wheel with which the wheel brake communicates;

FIG. 3 shows a brake pedal of the wheel brake disconnected from its wheel;

FIG. 4 shows the brake pedal of the wheel brake pivotally coupled to a wheel bracket of the wagon and rotated to a locked position for receipt by a locking gear that is attached to a hub of the wheel;

FIG. 5 shows the brake pedal of the wheel brake after being rotated from the locked position of FIG. 4 to an unlocked position at which to be removed from the locking gear;

FIG. 6 is a front view of the wheel shown in FIG. 1 and wheel brake communicating with the locking gear that is attached to the hub of the wheel;

FIGS. 7 and 8 are left and right side exploded views showing the wheel, the wheel bracket, the locking gear, covers for spokes of the wheel, and a bolt to be moved axially through the wheel and the locking gear to establish an axle around which the wheel and the locking gear can rotate with one another;

FIGS. 9 and 10 are enlarged left and right side perspective views showing the locking gear to be attached to the hub of the wheel;

FIG. 11 is an exploded cross-sectional view of the wheel and the locking gear shown in FIGS. 7 and 8 with the bolt aligned to be moved axially therethrough; and

FIG. 12 is a cross-sectional view showing the bolt of FIG. 11 after being moved axially through the wheel and the locking gear to establish the axle around which the wheel and the locking gear rotate with one another.

### DESCRIPTION OF THE PREFERRED EMBODIMENT

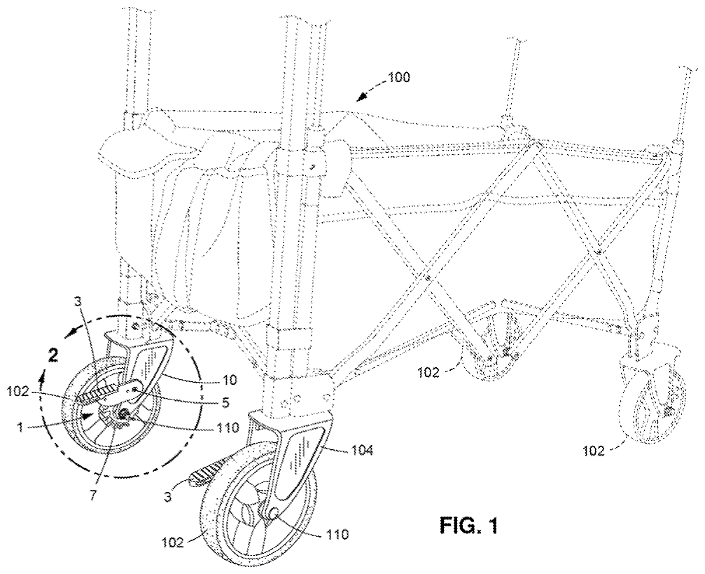

The wheel brake 1 which forms the present invention is now disclosed while retelling to the drawings, FIG. 1 illustrates a folding wagon 100 to which the wheel brake 1 has particular application. An example of one such wagon to which the wheel brake 1 has application is available by referring to U.S. Pat. No. 9,145,154 issued Aug. 27, 2015. However, it is to be understood that the folding wagon of FIG. 1 is shown for purposes of example only, and the advantages of this invention are applicable to other wagons, whether folding or not, and to wheeled articles other than wagons.

The wagon 100 shown in. FIG. 1 includes four (e.g., polyurethane) wheels 102 located at the four corners thereof by which the wagon rolls from place to place. Each wheel 102 is connected to one corner of the wagon 100 by means of a U-shaped wheel bracket 104. The U-shaped bracket 104 has a pair of wings 106 and 108 that are spaced from one another in opposite facing alignment to receive the wheel 102 therebetween. A threaded bolt 110 runs through the wings 106 and 108 and the wheel 102 to create an axle around which the wheel and a soon to be described locking gear 7 can rotate.

A wheel brake 1 is shown communicating with each one of a pair of the wagon wheels 102. It is also to be understood that a wheel brake 1 can be associated with more or less than the pair of wheels 102 as shown in FIG. 1. What is more, a wheel 102 with which a wheel brake 1 communicates can be located at the front the rear or both the front and the rear of the wagon 100. As will also be explained, the wagon 100 may be advantageously held in place in response to a user manually applying a pushing force to the wheel brake 1 so that a braking force is applied to the wheel 102 to prevent the wheel from rotating and the wagon from rolling from one place to another.

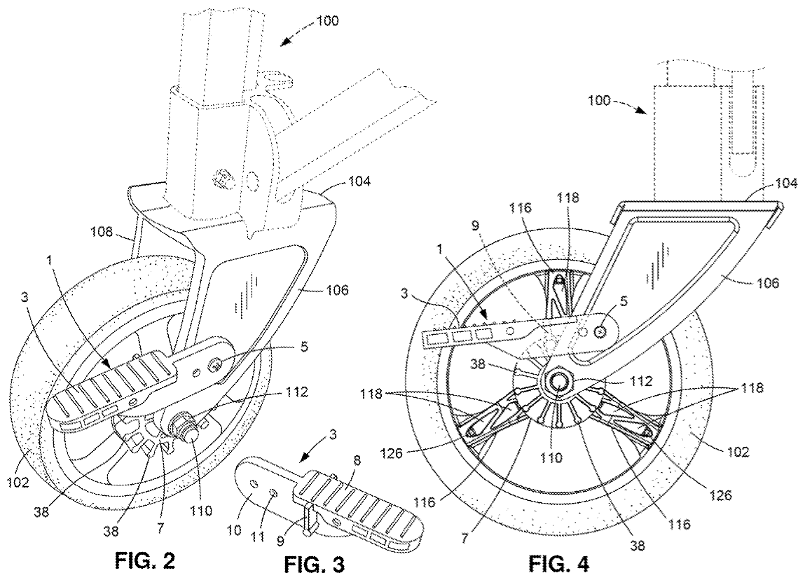

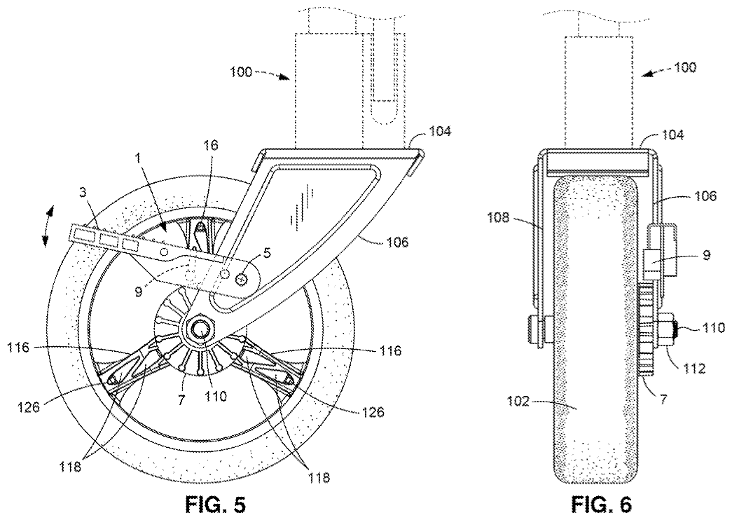

FIGS. 2 and 4-6 of the drawings show one wheel brake 1 connected to a corresponding wheel 102 located at one corner of the wagon 100. The wheel brake 1 includes a brake pedal 3 that is pivotally connected by means of a fastener 5 to one wing 100 of the U-shaped wheel bracket 104. The brake pedal 3 is rotatable at the fastener 5 between a locked position (shown in in FIG. 4) and an unlocked position (shown in FIG. 5). FIG. 3 of the drawings shows the brake pedal 3 having push pad 8 against which a pushing force is applied. A coupler (e.g., a locking pin) 9 depends downwardly from the push pad 8 of the brake pedal 3. The push pad 8 lays on a flange 10, and a mounting hole 11 is formed through the flange through which the fastener 5 is received by which the brake pedal is pivotally connected to the wing 106 of the wheel bracket 104.

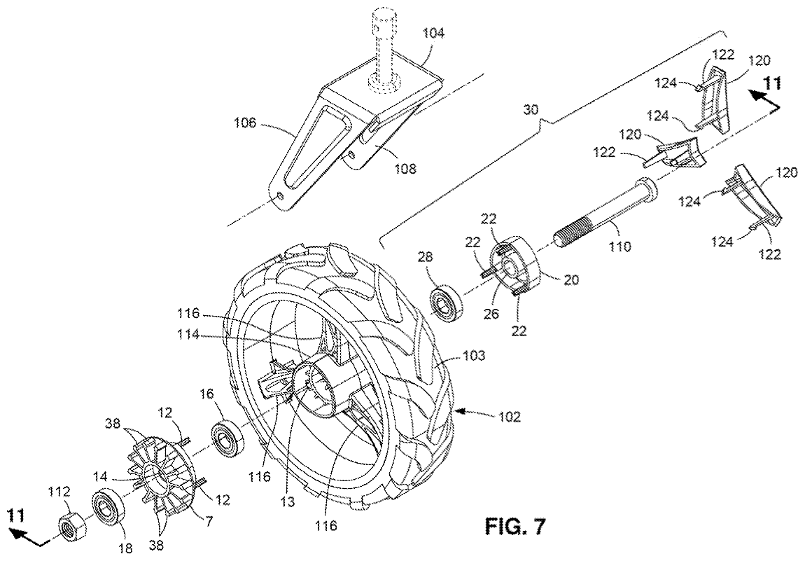

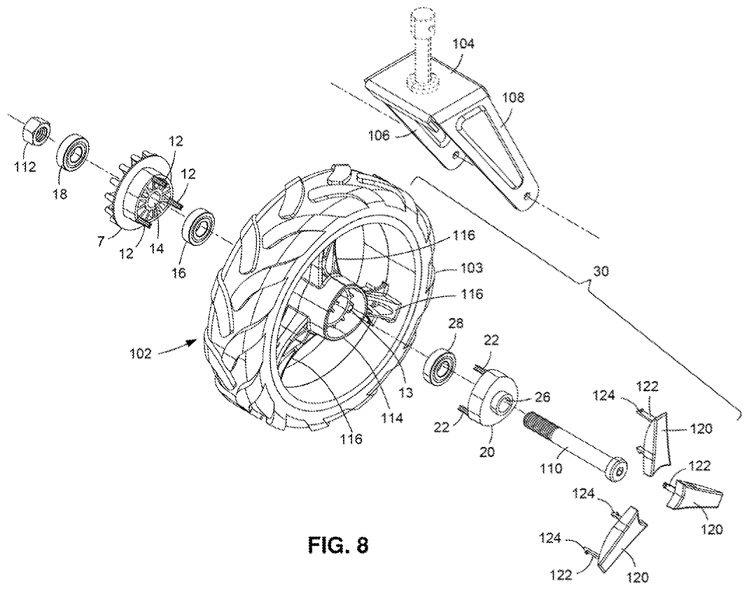

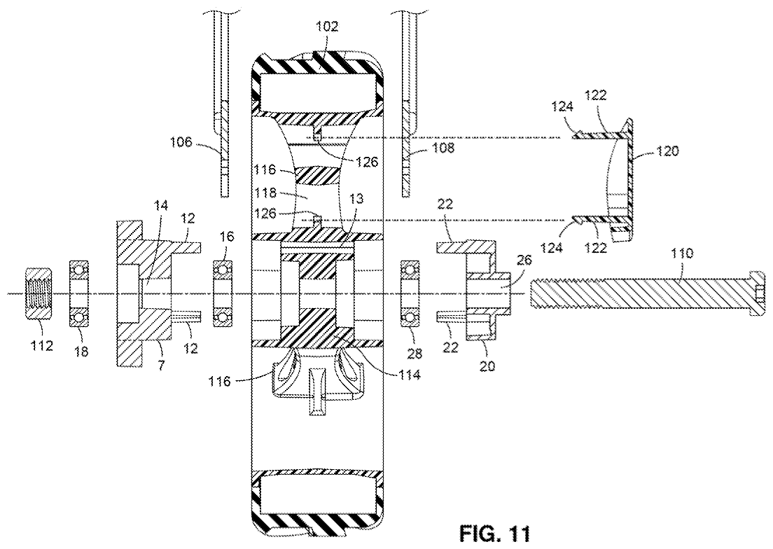

The threaded bolt 110 that runs through the wheel 102 to create an axle also runs through a locking gear 7 (best shown in FIGS. 10 and 11) by which to hold the gear 7 in axial alignment with a hollow hub 114 (best shown in FIGS. 7 and 8) of the wheel 102. A pushing force applied to the top of the brake pedal 3 at the push pad 8 thereof causes the brake pedal to rotate downwardly at the fastener 5 to its locked position of FIG. 4. Accordingly, the coupler 9 that depends downwardly from the brake pedal 3 moves into locking engagement with the locking gear 7 to prevent a rotation of the wheel 102 and a displacement of the wagon 1. When it is desirable to relocate the wagon, an opposite pulling force applied to the brake pedal 3 causes the brake pedal to rotate upwardly to its unlocked position of FIG. 3. In this case, the coupler 9 of the brake pedal 3 is lifted out of its former locking engagement with the locking gear 7 to permit a rotation of the wheel 102 and a displacement of the wagon 100.

FIGS. 7 and 8 of the drawings show the wheel 102 with its hollow hub 114 located at the center thereof. A set of (e.g., three) wide spokes 116 extend radially from the hub 114 to the inside of the tire 103 that surrounds the hub. Each spoke 116 has a pair of insert cover cavities (designated 118 and best shown in FIGS. 4 and 5). Me cavities 118 are closed by a corresponding set of (e.g., three) spoke insert covers 120. Each spoke insert cover 120 has a pair of flexible locking clips 122 extending outwardly therefrom and a locking tab 124 located at the end of each locking clip 122.

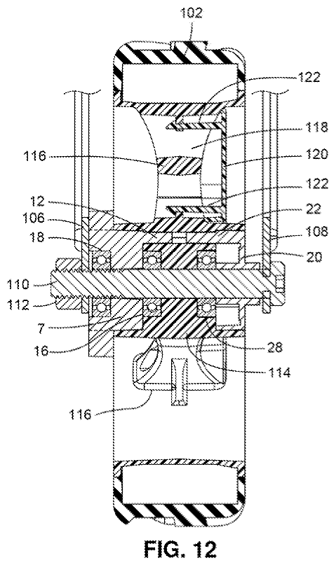

Each spoke insert cover 120 is attached over the face of a spoke 116 of wheel 102 when the pair of locking clips 122 of cover 120 are inserted into a corresponding pair of clip catches 126 (best shown in FIG. 11) that extend from the spoke into the insert cavities 118 thereof. As is best shown in FIG. 12, the locking tabs 124 at the ends of the flexible locking clips 122 of the spoke insert cover 120 are snapped into locking engagement with respective clip catches 126 of the spoke 116. With the spokes 116 covered by spoke insert covers 120, the vibrations to which the wheel 102 is typically subjected as the wagon rolls from place-to-place can be advantageously minimized,

Continuing to refer to FIGS. 7 and 8, the aforementioned locking gear 7 is shown to be detachably connected to a first side of the wheel 102. In particular, a coupling side of the locking gear 7 is seated within the hub 114. To this end, a set of (e.g., three) gear insert fingers 12 project from the coupling side of the gear 7. The gear insert fingers 12 are sized to be inserted into receipt one end of a corresponding set of finger channels 13 (only one of which being shown in FIGS. 7, 8 and 13) that runs continuously through the hub 114 along the sides thereof. The gear 7 is connected to the hub 114 at the finger channels 13 so as to be rotated with the wheel 102 once the bolt 110 that forms the wheel axel runs through both the hub 114 and a bore hole 14 formed in the center of gear 7. A pair of gear bearings 16 and 18 that surround the bolt 110 are positioned at opposite coupling and locking sides of the locking gear 7. As previously explained, a nut 112 is tightened against the bolt 110 to prevent the bolt from being pulled out of the wheel 102 and separating from the gear 7 and its bearings 16 and 18.

Attached to the wheel 102 opposite the side thereof at which the locking gear 7 is connected is a detachable wheel insert 20. Like the gear 7, the wheel insert 20 has a set of (e.g., three) wheel insert fingers 22 projecting therefrom. The wheel insert fingers 22 are sized to be inserted into receipt by the opposite ends of the aforementioned finger channels (designated 13 in FIGS. 7, 8 and 11) that run continuously through the hub 114 of the wheel 102. As is best shown in FIG. 12, the wheel insert 20 is seated within the hub 114 and connected to the wheel 102 at the finger channels 13 when the bolt 110 runs through both a bore hole 26 formed in the center of the wheel insert 20 and the hub 114. A wheel insert bearing 28 surrounds the bolt 110 to lie between the wheel insert 20 and the hub 114.

As another advantage of this invention, by first removing the bolt 110 from the wheel 102, the wheel can be separated from its wheel bracket 104 and the locking gear 7. Thus in cases where the wheel brake disclosed above is not needed, a wheel assembly (designated 30 in FIGS. 7 and 8) is available to be conveniently connected, without the gear 7 and by means of the bolt 110, to other articles which roll from place to place on the wheel 102. In this case, the locking gear 7 is removed from the wheel 102 by pulling the gear insert fingers 12 out of their finger channels 13 formed in the hub 114.

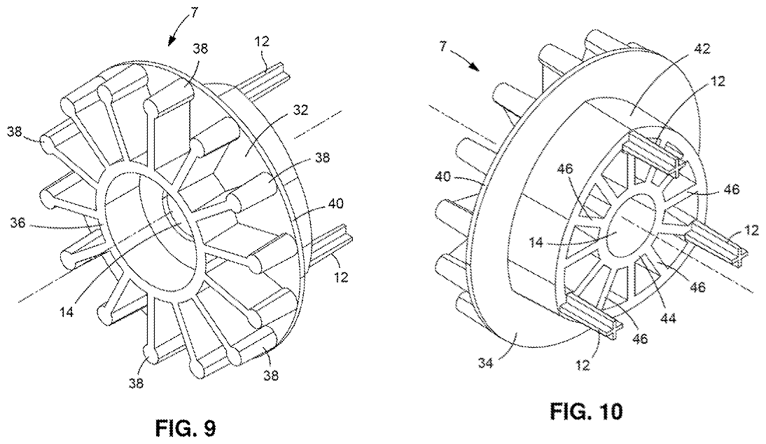

Details of the locking gear 7 are now described while referring to FIGS. 9 and 10 of the drawings. The locking gear 7 which is preferably manufactured from plastic has braking side 32 (best shown in FIG. 9) and an opposite coupling side 34 (best shown in FIG. 10). As previously explained, a bore hole 14 runs through the center of the gear 7 through which to receive the threaded bolt (designated 110 in FIGS. 7 and 8) so that the gear is axially aligned and rotates with the wheel 102.

A cylindrical riser 36 surrounds the bore hole 14 through the braking side 32 of the locking gear 7. A plurality of gear teeth 38 extend radially outwardly from the riser 36. The riser 36 and the gear teeth 38 lay on a disc-shaped base 40 that is located between the braking and coupling sides 32 and 34 of the gear 7. The gear teeth 38 are evenly spaced from one another around the periphery of the riser 36. The space between successive pairs of the gear teeth 38 is chosen to be able to accommodate the coupler (designated 9 in FIG. 3) that depends from the push pad 8 of the brake pedal 3.

As was previously explained while referring to FIGS. 4 and 5, when it is desirable to lock the wagon 100 in place, a pushing force applied to the push pad 8 of the brake pedal 3 causes the brake pedal to rotate at the pivot fastener 5 downwardly towards the gear 7 from the unlocked position of the brake pedal shown in FIG. 5 to the locked position shown in FIG. 4. With the brake pedal 3 in its locked position, the coupler 9 of brake pedal 3 is received between a pair of the gear teeth 38 of the locking gear 7. The receipt of the coupler 9 by the locking gear 7 prevents both a rotation of the wheel 102 to which the locking gear 7 is connected and a displacement of the wagon 100. When it is desirable to relocate the wagon 100, the brake pedal 3 is lifted up and rotated upwardly towards its unlocked position of FIG. 5. whereby the coupler 9 is moved out of its receipt by the teeth 38 of the gear 7 and the wheel 102 is now free to rotate,

Standing outwardly from the coupling side 34 of the locking gear 7 is a coupling block 42 that is seated on the base 40 (best shown in FIG. 10), A cylindrical riser 44 that is located at the center of the coupling block 42 surrounds the bore hole 14 through the coupling side 34 of the gear 7. A plurality of reinforcement walls 46 extend radially between the riser 44 and the outside of the coupling block 42. The reinforcement walls 46 are evenly spaced from one another around the coupling block 42. The reinforcement walls 46 provide structural integrity and strength to reduce the risk that the gear 7 will crack when the wagon transports a heavy load that is transferred to the wagon wheels. The previously described gear insert fingers 12 extend outwardly from the coupling block 42 for receipt by the finger holes (designated 13 in FIG. 7) within the hub 114 by which the locking gear 7 is connected to and rotated with the wheel 102. As is best shown in FIGS. 11 and 12, with the locking gear 7 connected to the wheel 102, the coupling block 42 at the coupling side of sear 7 is received inwardly of the ho low hub 114 of the wheel 102.

1. A combination comprising:
a wheeled article including at least one wheel on which to roll from place to place and a bracket by which to attach said wheel to said wheeled article; and
a wheel brake pivotally coupled to said bracket and being rotatable between locked position at which to prevent a rotation of said wheel and thereby hold said wheeled article in place and an unlocked position at mind to permit a rotation a said wheel and a displacement of said wheeled article from one place to another.

2. The combination recited in claim 1, wherein said wheel brake is responsive to each of a pushing force manually applied thereto to cause said wheel brake to rotate in a first direction from said unlocked position to said locked position and a pulling force manually applied thereto by which to cause said brake to rotate in an opposite direction from said locked position to said unlocked position.

3. The combination recited in claim 2, wherein said wheel has a hub and said combination further comprises a locking gear attached to said wheel at said hub so as to rotate with said wheel when said wheeled article rolls from place to place, said wheel brake rotating in said first direction to said locked position at which to lie in locking engagement with said locking gear so as to prevent a rotation of said wheel and thereby hold said wheeled article in place.

4. The combination recited in claim 2, wherein the hub of said wheel to which said locking gear is attached is located at the center of said wheel and the bracket of said wheeled article has a pair of wings that are spaced from one another between which said locking gear is located, said wheeled article also including a fastener extending through each of said pair of wings, said locking gear located between said pair of wings, and said hub to create an axle at which said wheel and said locking gear rotate with one another when said wheeled article rolls from one place to another.

5. The combination recited in claim 4, wherein said wheel also has a tire surrounding said hub, a set of spokes extending radially between said hub and said tire, and a corresponding set of spoke covers laying over and connected to respective ones of said set of spokes.

6. The combination recited in claim 5, wherein each one of said set of spokes has a clip catch formed therein and each one of said corresponding set of spoke covers has a locking clip extending therefrom, said locking, clips being received within respective ones of said clip catches by which said set of spoke covers are connected to said set of spokes.

3. The combination recited in claim 3, wherein the hub of said wheel has a set of finger channels formed therein and said locking gear has a corresponding set of locking fingers projecting therefrom, said set of locking fingers being received within respective ones of said set of finger channels by which said locking gear is attached to said hub so as to be rotatable with said wheel.

8. The combination recited in claim 3, wherein said locking gear has a plurality of gear teeth that are spaced from one another and said wheel brake has a brake pedal to which said manual pushing force is applied to cause said brake pedal to rotate in said first direction to the locked position of said wheel brake so as to be located between a successive pair of gear teeth of said locking gear by which to prevent the rotation of said wheel and thereby hold said wheeled article in place.

9. The combination recited in claim 8, wherein the brake pedal of said wheel brake has a locking coupler extending therefrom to be moved between a successive pair of the gear teeth of said locking gear when said brake pedal rotates in said first direction to the locked position of said wheel brake so as to prevent the rotation of said wheel and thereby hold said wheeled article in place.

10. The combination recited in claim 1, wherein said wheeled article is a wagon.

11. A combination comprising:
a wheeled article including, at least one wheel on which to roll from place to place;
a wheel brake attached to said wheeled article and being movable a first direction to a locked position at which to engage said wheel to prevent a rotation of said wheel and thereby hold said wheeled article in place and being movable in an opposition direction to an unlocked position at which to be disengaged from said wheel so as to permit a rotation of said wheel and a displacement of said wheeled article from one place to another; and
a locking gear connected to said wheel and being rotatable therewith, said wheel brake engaging said locking gear in said locked position by which to correspondingly communicate with said wheel.

12. The combination recited in claim 11, wherein said wheeled article is a wagon.

13. The combination recited in 11, wherein said locking gear has a plurality of gear teeth that are spaced from one another and said wheel brake has a brake pedal that is movable in said first direction so as to be located between a successive pair of the gear teeth of said locking gear by which to communicate with said wheel so as to prevent a rotation of said wheel and thereby hold said wheeled article in place.

14. The combination recited in claim 11, wherein said wheel brake is pivotally attached to said wheeled article so as to be rotatable in said first and opposite directions between said locked and unlocked positions.

15. The combination recited in claim 11, wherein the wheel of said wheeled article has a hub located at the center thereof, said locking gear connected to said wheel at said hub.

15. The combination recited in claim 15, further comprising a fastener extending through the hub of said wheel and said locking gear connected to said hub to create an axle at which said wheel and said locking gear rotate with one, another when said wheeled article rolls from one place to another.
